(19) United States
(12) Patent Application Publication
(10) Pub. No.: US 2006/0017411 A1
(43) Pub. Date: Jan. 26, 2006

(54) Mobile/transportable PET radioisotope system with omnidirectional self-shielding

(75) Inventor: Robert W. Hamm, Pleasanton, CA (US)

Correspondence Address: ROBERT D. VARITZ, P.C., 4915 SE 33RD PLACE, PORTLAND, OR, 97202, US

(73) Assignee: AccSys Technology, Inc.

(21) Appl. No.: 11/125,029

(22) Filed: May 8, 2005

Related U.S. Application Data
(60) Provisional application No. 60/581,012, filed on Jun. 17, 2004.

(51) Int. Cl. H05H 9/00

(52) U.S. Cl. 315/505

(57) ABSTRACT

A linear accelerator system for producing PET radioisotopes, and taking the form of a beam-generation-to-target structure which includes form-fitting, self-contained, omnidirectional radiation shielding structure.

### CROSS REFERENCE TO RELATED APPLICATION

This application claims priority to U.S. Provisional Patent Application Ser. No. 60/581,012, filed Jun. 17, 2004, for “Mobile/Transportable PET Radioisotope System with Omnidirectional Self-Shielding”. The entire content of that prior-filed, currently copending U.S. provisional application is hereby incorporated herein by reference.

### BACKGROUND AND SUMMARY OF THE INVENTION

This invention pertains to Positron Emission Tomography (PET), and more particularly to a unique, compact, self-shielding system for PET radioisotope production, and to the special form factor, or configuration, per se of such a system. PET radioisotopes play a widely recognized, growingly significant role in modem radiation therapies, and the present invention offers an appreciable new opportunity for making these therapies more widely accessible and available through enabling a more readily attainable, wide and economic distribution of PET radioisotope production capabilities.

In this context, and as will be seen, in addition to utilitarian uniqueness which is expressed in this invention through the special self-shielding nature of key, high-energy particle-accelerator and particle-beam-transport components which make up portions of the system of the invention, this special “nature” leads to a unique, compact system form factor (defined-configuration and shape). This form factor enables the system to be (a) easily transported by, and readily deployed in and from, various conventional kinds of transportation vehicles (land, water and air), (b) used in a very wide range of spatial orientations, and (c) disposed for use in very modest and inexpensive facilities which do not need to furnish conventional, building-structure-type, room-sized shielding structure.

The basic radioisotope production components of the proposed system are arranged in a straight-linear, elongate fashion, and progressing through the system from the low-energy end to the high-energy end, include: (a) an ion injector source; (b) a low-energy beam transport (LEBT); (c) a radio frequency quadrupole (RFQ); (d) a drift tube linear accelerator, or linac, (DTL); (e) a high-energy beam transport (HEBT); and (f) a target, or target structure.

To aid in appreciating certain technical background information which is helpful in understanding the nature of the present invention, reference is here made to two, currently living U.S. Pat. Nos. 5,179,350 and 5,315,120. To the extent that the disclosures in these two patents are useful regarding an understanding of the present invention, they are hereby incorporated by reference into this disclosure. U.S. Pat. No 5,179,350 discloses details of construction of a DTL which may be employed preferably in the practice of this invention. Similarly, U.S. Pat. No. 5,315,120 discloses certain core structure in an RFQ which also is preferably employable in the structure and practice of the present invention.

As it is well known to those generally skilled in this art, it is critical that an overall device like that which is disclosed in this patent application be very adequately shielded so as to prevent exposure to radiation with respect to people who work near and around such a system. In most instances, the conventional practice implemented to achieve shielding from such radiation involves the building, around a core accelerator device, of large room-like structures which are constructed with appropriate shielding. Such shielding structure is not part of the shielded device per se, but rather occupies, typically, considerable and costly space in a building structure. Given this prior art condition, it is also the case that installation of a PET radioisotope production system cannot be afforded in many areas where it might be useful and important, particularly because of the fact that the conventional approach to providing adequate shielding for such a system involves the constructing of a fairly robust and elaborate building structure with a room, or rooms, especially designed for radiation shielding.

As will be seen, the present invention offers a PET radioisotope production system which is highly mobile and transportable, relatively small in size, capable of being positioned for use in virtually any orientation, and self-contained with respect to shielding against harmful radiation. The shape, or form factor, of the proposed system is unique and very relevant to these considerations in that, effectively, all radiation shielding is built directly into the linear accelerator components themselves—an approach which results in the overall system being very compact in size, and easily transportable in a variety of ways (land, water, air). More specifically, the system proposed by this invention has what is referred to herein as a bulb-and-stem, or lollipop, physical configuration, wherein the stem part of the system takes the form of elongate, linearly aligned components leading up to the target structure, and the target structure is made as compactly as possible because of its bulblike, roughly spherical shape.

With this concept implemented by the system of this invention, the system can be installed virtually anywhere without any need for the construction of a special building space which itself is formed with radiation shielding structure. The compact form factor of this invention also yields a system, which as was just suggested above, is easily transportable over land, water, and by air.

The special features of this invention are focused (a) on the invention's proposed unique form factor, and (b) upon the fact that this form factor results from the direct incorporation of radiation shielding structure as component parts per se, of the different components in the system. The system embodies its own, self-contained, fully capable radiation shielding structure.

With the invention specifically having a focus on these features, it should be understood that the internal workings and details of construction of the various particle beam accelerator and transport components do not form any part of the present invention. Accordingly, such details are not described herein. Those generally skilled in the art will recognize, from the description which follows below, how it is possible to implement the present invention with various difference specific types of linear accelerator components properly assembled and employed. They will also recognize how various dimensions and materials selections may be varied to suit different specific applications.

The four radioisotopes which are most commonly used in Positron Emission Tomography, fluorine-18, carbon-11, nitrogen-13, oxygen 15, all decay rapidly, and have short lifetimes, with half lives ranging generally from about 2-minutes to about 110-minutes. Many facilities are now using mobile PET scanners in order to bring PET imaging techniques to remote areas, but they can practically only do these kinds of scans relatively near a site where an accelerator is located to produce the required PET radioisotopes. Because of the short half-lives of the desired isotopes, transportation times between production sites and use (scanning) sites must be extremely short, and this, as a practical matter, requires that production facilities be located physically quite close to use facilities. With longer distances between production and use sites, transportation costs simply become prohibitively high, and as a consequence, relatively remote, rural areas do not have ready access to this technology.

In this kind of a setting, it is obviously important to consider structural improvements in PET radioisotope production apparatus which will permit such apparatus easily to be brought and/or placed very close to sites where PET scanning activities are to take place.

As will be seen from the description of the invention set forth below, the system of the present invention directly and effectively addresses these important time and distance issues.

As will be seen, the system of the invention offers a very high degree of ready mobility, inasmuch as it is relatively small in size, light in weight, and configured easily to be transported in over-land trailers, as well as over the water and in the air. This significant size and mobility set of features of the invention allow it to be used, for example, as a local base of radioisotopes and labeled pharmaceuticals for several mobile PET or PET/CT scanner units that would allow their bases of operation to be moved easily into various rural areas of the country. Further, the system of the present invention can function as a fully mobile source of very short-lived PET radioisotopes, and thus, because of the ease of positioning and moving the system of this invention very closely near use facilities, allows these facilities ready access to employment of short half-life radioisotopes.

Additionally, the system of the invention may also be used as a temporary laboratory for a facility during construction of a new and more fixed (in place) PET radioisotope production facility.

The effective self-shielding nature of the system of this invention, travels, so-to-speak, as an integral unit with the system per se, and avoids the necessity of requiring the fabrication of expensive and large containment facilities. Very importantly, it allows the system of this invention to have its components oriented in any desired configuration in space without there being any concern for having to provide special external radiation shielding to accommodate such an orientation. Thus, and for example, a system of the present invention transported in an over-land trailer which may be brought to an area and parked in any one of a myriad of different orientations, raises no issue with respect to having to consider building specially oriented and sized external shielding walls, floor, ceilings, etc.

As will also become apparent to those skilled in the art, the various beam-creating and generating components of the system do not require extraordinary power, or other specialized utilities infrastructure, in order to be readily operable in substantially all areas of the country.

These and other features and advantages which are offered by the present invention will become more fully apparent as the description which now follows is read in conjunction with the accompanying drawings.

### DESCRIPTION OF THE DRAWINGS

FIG. 1A is a very simplified schematic illustration (a side elevation) of the PET radioisotope production structure (system) proposed by the present invention. In this figure, the components which make up this system are illustrated lying substantially along, and in alignment with, a horizontal line which defines the operational axis (the beam axis) of the system.

FIG. 1B is an enlarged, simplified, fragmentary cross-sectional view taken generally along the line 1B-1B in FIG. 1A.

FIG. 2 presents, on a slightly larger scale than that which is employed in FIG. 1A, a more detailed, side-elevational view of the system components which are also shown in FIG. 1A.

FIG. 3 is a still further enlarged, photographic view of the system of this invention, showing, in an isometric fashion, the more detailed picturing of the system which appears in line-drawing form in FIG. 2. In FIG. 3, a human figure is shown working at the target end of this system, and thus offers a clear illustration of the relatively small size and scale of the system of the invention.

FIG. 4 is an enlarged, isolated, fragmentary, “opened up” view illustrating just the target, or target structure, portion of the system of the invention.

FIG. 5 is a view illustrating shielding structure which is employed with respect to the HEBT portion of the system of the invention.

FIG. 6 illustrates the system of this invention installed as a mobile unit for over-land transportation, and for use in a relatively conventional, tractor-haulable trailer.

FIG. 7 presents a fragmentary, isolated, isometric view of an alternative form of shielding structure which is useful with the HEBT portion of the system of the invention.

FIGS. 8 and 9 are, respectively, highly simplified schematic views generally illustrating transport of the system of this invention over water, and by air, respectively.

### DETAILED DESCRIPTION OF THE INVENTION

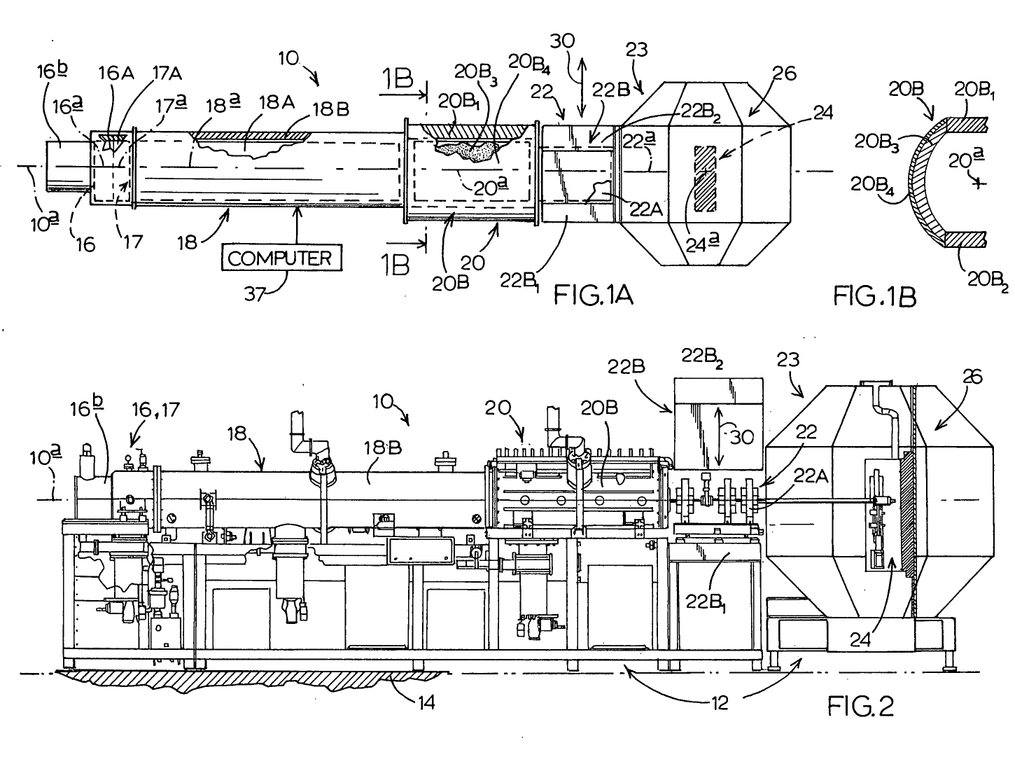

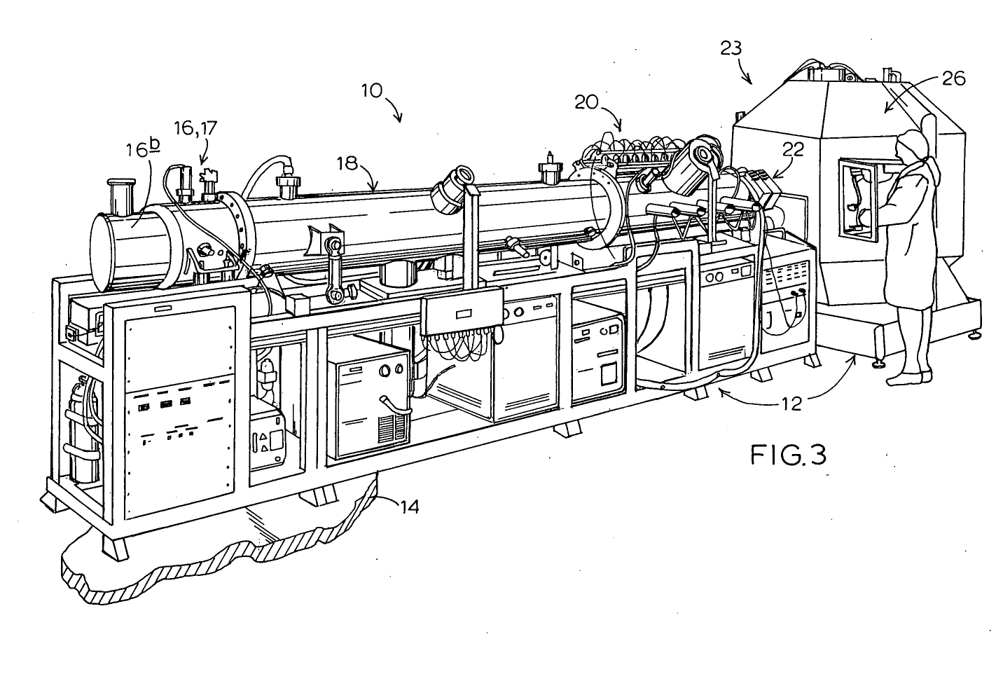

Turning attention now to the drawings, and referring first of all more particularly to FIGS. 1-3, inclusive, indicated generally at 10 is a PET radioisotope production system, also referred to herein both as a defined-configuration system for PET radioisotope production constructed and as a beam-generation-to-target structure. System 10 operates in accordance with the preferred and best-mode embodiment of the present invention. In FIG. 1 the basic, or core, components of system 10 are illustrated in what can be thought of as being an isolated, though unified, fashion—that is to say, without showing any underlying support framework. FIGS. 2 and 3, however, show this very same system in slightly greater detail, with FIG. 3 picturing an actual test insulation of the system of the invention, where the same core components are illustrated supported through an elongate, distributed framework 12 which is shown resting on a support floor 14 of any suitable nature.

Important to notice particularly in FIGS. 1A, 2 and 3 is the unique defined configuration, or form factor, which characterizes system 10. In particular, this configuration, or form factor, has the appearance which can be likened to that of a bulb and an associated elongate, slender stem (i.e., bulb-and-stem), and also as a lollipop. This configuration, as will become apparent, results from the fact that, in accordance with the present invention, the various beam-creating components of system 10 are essentially self-shielded with close, form-fitting radiation-shielding structures.

Support framework 12 put aside for the moment, the other components of system 10, as illustrated in isolated form in FIG. 1A, make up the entirety of that portion of the system which requires (and only in certain regions) full omnidirectional shielding in order to be safely employable whenever it is put to use. The fact that self-shielding exists because of this configuration results in system 10 being useable without there being any requirement for special surrounding, radiation-shielding building considerations. In fact, with the system in full operation, personnel can work safely immediately adjacent (as well as beneath) its components.

Included in system 10, and effectively operating and generating ultimately a high-energy ion beam along a system axis shown at 10a, are an elongate ion source injector 16 having a long axis 16a which is coincident in axis 10a, an elongate, Low-Energy Beam Transport (LEBT) 17 having a long axis 17a which aligns with axes 10a, 16a, an elongate Radio Frequency Quadrupole (RFQ) 18 having a long axis 18a which is also coincident with system access 10a, an elongate Drift Tube Linac (DTL) 20 possessing a long axis 20a which is also coincident with this system axis 10a, an elongate High-Energy Beam Transport (HEBT) 22 having a long axis 22a which also aligns with system axis 10a, and finally, a target, or bulb, structure 23 having a target zone 24 which, as is indicated generally at 24a in FIG. 1A, sits substantially centered on system axis 10a. Zone 24 is disposed within a generally spherical, hinged-assembly, bulb-like, omnidirectional target shield 26. Supporting the underside of target shield 26 is a small portion of framework structure 12.

Helping to illustrate the small size, and generally the scale, of system 10, appearing adjacent the right side of FIG. 3 in the drawings is a human figure whose height can be seen to be just a little bit less than that of the overall height of system 10. This overall height is determined principally by the stack height of target shield 26 and its underlying support framework 12.

Ion source 16, LEBT 17, RFQ 18, and DTL 20 collectively form what is referred to herein as an ion-beam linear accelerator, or linac structure, and also as a stem. The left end of this structure in the figures is defined by ion source 16, and this end is referred to herein as an upstream end, or region, in the linac structure. The downstream end of the linac structure is defined by the far, or right, end of DTL 20, and is referred to herein both as the downstream end, or region, of the linac structure, and also as the discharge end of that structure. Ion source 16 is also referred to herein as an ion injector.

This arrangement (ion source 16 and LEBT 17) is generally well known to those skilled in the art, and does not require particular elaboration.

With reference made particularly to FIG. 1 in the drawings, ion source 16 includes internal working structure 16A which is provided with an appropriate high-voltage shield 16b. LEBT 17 includes internal working structure 17A. As they appear in the drawings herein, source 16 and LEBT 17 are elongate and cylindrical in nature. Ion injector 16 represents the low-energy end of system 10, and does not require any particular special form of radiation shielding. The left end of source 16 in FIG. 1 is referred to as the upstream end of the injector, and the right end thereof is referred to as the downstream end of the injector.

RFQ 18 also has an elongate and somewhat cylindrical structure, including internal RFQ working structure 18A contained within an outside, wrap-around, radiation shielding body 18B, generally cylindrical in nature, and which is also referred to herein as being part of a first radiation-shielding substructure. The left end of RFQ 18 herein is referred to as its upstream end, and the right end of this RFQ structure is referred to as its downstream end. One can therefore see that the downstream end of ion injector 16 is operatively coupled directly to the upstream end of RFQ 18, with axes 16a, 18a in these two components in system 10 aligned with one another and with system axis 10a, as was mentioned earlier.

RFQ working structure 18A is made herein principally in accordance with teachings found in the '120 U.S. Patent mentioned above. Details of these features of the RFQ do not form any part of the present invention, and thus are not elaborated herein.

The form-fitting outer shielding body portion 18B of RFQ 18 defines an operating vacuum chamber for the RFQ, and is formed herein preferably of ⅜-inches stainless steel. This structure functions very effectively as, essentially, an omnidirectional radiation shield for and around the structure of the inner workings of RFQ 18.

Appropriately coupled to the high-energy (right) end of RFQ 18 in system 10 is previously mentioned DTL 20 which includes inner workings 20A (as described in U.S. Pat. No. 5,179,350), and integrated outer shield structure 20B whose configuration and make up will now be described. Shield 20B, which is also referred to herein as a cylindrical wrap-around structure, includes upper and lower planar elements 20B₁, 20B₂, respectively, which are formed preferably of about 2-inches to about 3-inches thick mild steel. Opposite lateral sides of shield structure 20B are arcuate, as can best be seen in FIG. 1B, and are formed as a two-layer structure including an inner curved expanse of ⅜-inches mild steel jacketed on its outside by a ¼-inch thick curved layer of lead. In FIG. 1B, an inner curved mild steel component of a side structure is shown at 20B₃ and the outer jacketing lead layer is shown at 20B₄. Structure 20B also forms part of the previously mentioned first radiation-shielding substructure.

DTL outer body structure 20B, which performs integral shielding respecting radiation present within DTL 20, is shown herein best in FIGS. 1A and 1B, with sufficient outer details removed from these figures so that the shielding structure per se can be perceived. FIGS. 2 and 3 illustrate external details which, as can be seen, somewhat obscure the character of integral shielding provided by structure 20B.

Elongate HEBT component 22 in system 10 is, with the exception of the presence of an integrated, wrap-around, omnidirectional, outside shield structure, entirely conventional with respect to its internal workings. It functions principally to transport and guide the high-energy ion beam exiting from the discharge end (the right end in the figures) of DTL 20 toward and into target zone 24 in target structure 23. In FIG. 1A and FIG. 2, the inner workings 22A, and the components of a preferred form of outer, integrated, omnidirectional shielding structure 22B, for HEBT 22 are shown in different conditions relative to one another. More specifically, in FIG. 1A the integrated shield structure 22B (a two-component structure) is shown in a condition fully shielding HEBT 22. In FIG. 2, the inner workings 22A, and the two-component shield structure 22B, are shown adjusted, so-to-speak, to reveal the inner working structure of the HEBT. The embodiment of shield structure 22B illustrated in FIG. 1A and 2 includes a base component 22B₁ and an overhead component 22B₂.

Looking specifically at FIG. 5, the components that make up the integrated and generally form-fitting radiation shield structure specifically for HEBT component 22 are formed preferably of about 8-inches thick borated polyethylene panels 22B₃ jacketed by a thin (approximately ⅛-inches thick) metal skin 22B₄ made of aluminum.

The shield structure specifically shown in FIGS. 1A and 2 for HEBT 22, which structure also forms part of the earlier mentioned first radiation-shielding substructure, separates by lifting of the upper component, as illustrated by double-ended arrow 30 in these two figures, so as to expose the inner working components of the HEBT.

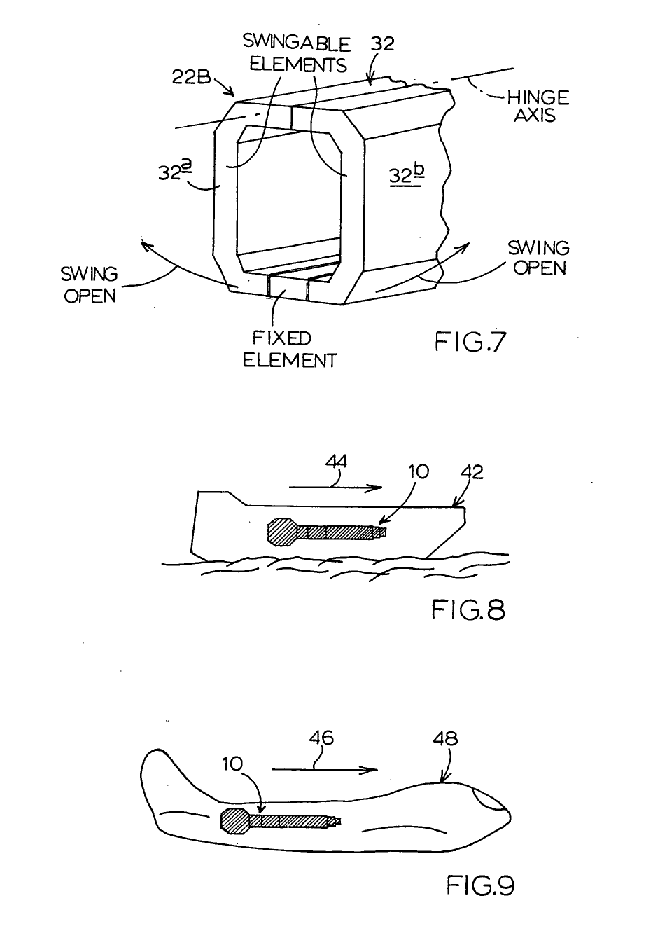

FIG. 7 illustrates one alternative form for structure 22B, which form is slightly more form-fitting than that which is pictured in FIGS. 1A, 2 and 5 in the drawings. This alternative structure, designated generally 32 in FIG. 7, is prepared, as can be seen, as a hinged structure, 32a, 32b which can be swung between open and closed conditions to reveal the inner components of the HEBT structure.

In system 10 as illustrated and described, the overall assembled length of components 16, 17, 18, 20 and 22 is about 14-feet. The effective maximum vertical and lateral dimensions relative to and centered on axis 10a are roughly equivalent to that of a cylinder having an outside diameter of about 2-feet. These five components, 16, 17, 18, 20, 22 make up the “stem” portion of the previously referred to bulb-and-stem configuration for system 10.

Turning attention now to the target structure, the internal target region per se can be constructed in a number of different and entirely conventional ways which do not form any part of the present invention. Rather, the present invention is concerned with the construction and configuration generally of the target shield structure 26 which, as has been mentioned, can be thought of as possessing a bulb shape, and as having a generally cylindrical shape. The specific target shield configuration illustrated herein, also referred to as a second radiation-shielding substructure, has the form of an icosihexahedron, as is clearly visible in the drawings.

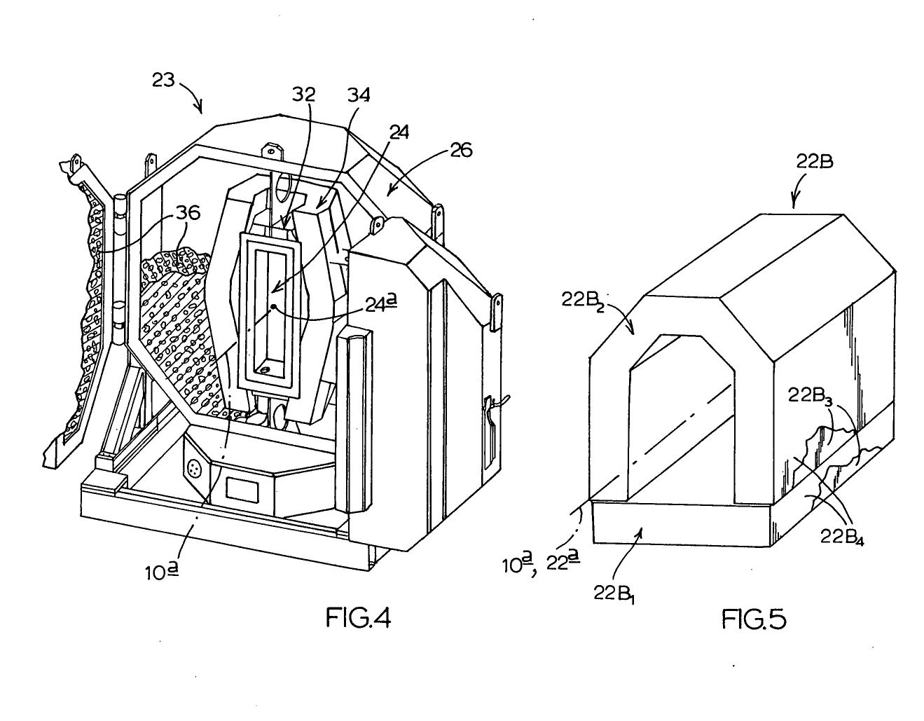

Looking now at FIG. 4 along with the other drawings figures, the overall target structure can be seen to be fabricated in such a way that shield structure 26 is a double-hinged assembly which is shown completely closed in FIGS. 1A, 2, 3, and 6, and isolated and “swung” open in FIG. 4. It should be understood that the precise details of construction within the target structure do not form any part of the present invention, and thus are not described herein in detail. One manner generally of constructing the overall target structure is pictured quite clearly in FIG. 4.

Immediately surrounding target zone 24 is a lead jacket 32 having a wall thickness of about 5-inches, and immediately surrounding this lead jacket is another jacket-like enclosure 34 formed of borated polyethylene and having a wall thickness of about 6-inches. The space around enclosure 34 is filled with concrete 36 which is loaded appropriately with polyethylene beads and boron carbide powder. This concrete mix per se forms no part of the present invention. Finally, the outer portion of target shield 26 is formed of mild steel with a wall thickness of about ½-inches. Thinking of structure 26 as being generally spherical in nature, this structure can be described as having a diametral dimension in system 10 of about 7-feet.

Completing a description of what is shown in FIG. 1, indicated in block form at 37 is an appropriately programmed digital computer which is operatively connected to various electronically controllable components in system 10 to direct the overall operation of the system. This computer, its operational software, and its specific connection to system 10, do not form any part of the present invention.

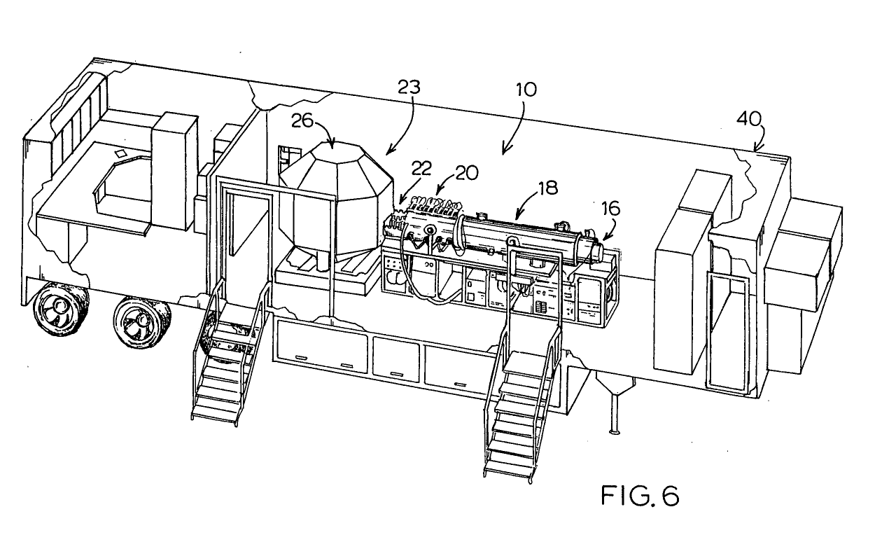

Another very important feature of the system of this invention is brought to attention in FIGS. 6, 8, and 9 in the drawings, wherein this system is shown deployed inside of three different modes (vehicles) of easily managed transportation. More specifically, in FIG. 6, system 10 is shown installed in a over-land trailer 40 in a manner which offers the system for use a completely mobile unit wherein it remains stationed within the body of the trailer. In the condition illustrated in FIG. 6, system 10 can conveniently be used effectively as a functional PET radioisotope production facility, without the need to off-load the system and place it in some other structure.

In FIG. 8, system 10 is shown loaded onto a water vessel, such as the barge shown schematically at 42 traveling over the water generally in the direction of arrow 44. Here, too, system 10 may be deployed for use directly in its stored condition on this barge, or it may be off-loaded for placement in some other facility without requiring external shielding in that facility.

In FIG. 9, system 10 is shown being transported in the direction of arrow 46 by an aircraft shown at 48.

The basic features of system 10 have thus been described. Various materials and specific dimensions have been mentioned herein, but it should be understood that these specific material choices and dimensions may be changed in well known ways to accommodate different situations. In other words, specific dimensions and material selections are not per se any part of the present invention.

The system of this invention is extremely versatile in nature, and clearly addresses the concerns and considerations mentioned earlier herein with respect to issues associated with conventional PET radioisotope reduction facilities. The fact that is carries its own self shielding structure, and does so by form-fitting shielding componentry which results in the overall system having what has been referred to herein as a lollipop, or bulb-and-stem, configuration, means that the system of the invention can easily be employed in a host of remote sites where conventional facilities today can simply not, as a practical matter, be made available.

An important consequence of this unique form factor is that the overall size and weight of system 10 are relatively small, with the overall length of system 10 disclosed herein being about 20-feet, and the overall weight being about 13-tons.

Because of the unique nature of the system of this invention, it can be employed in any orientation desired. No separate external shielding structure is required. With respect to the self-shielding character of system 10, it should be understood that the term “omnidirectional” describes a condition which is that a person working with the system can stand anywhere near it when it is in full operation without any fear of receiving harmful radiation. In other words, the term “omnidirectional” is intended to mean a condition of radiation shielding with respect to any and all possible locations outside of the system where personnel may be positioned.

Accordingly, while a preferred embodiment, and certain modifications and variations have been suggested herein, it is appreciated that other modifications and variations may be made without departing from the spirit of the invention, and it is intended that all claims herein will be understood to read upon such other variations and modifications.

I claim:

1. An elongate mobile, transportable, compact, defined-configuration system for PET radioisotope production, said system comprising
an ion-beam linear accelerator (linac structure) which is one part of said defined configuration,
a target zone which is another part of said defined configuration, operatively coupled to said linac structure and adapted to receive a target for illumination by an ion beam accelerated by said linac structure, and
generally defined-configuration-conforming, omnidirectional shielding structure forming a full radiation barrier shield around said linac structure and said target zone.

2. The system of claim 1, wherein said linac structure includes an elongate, generally cylindrical-body, radio frequency quadrupole (RFQ) having a long axis, and said shielding structure includes generally cylindrical wrap-around outside structure directly associated with said RFQ and wrapped around said long axis.

3. The system of claim 1, wherein said linac structure includes an elongate, generally cylindrical-body drift tube linac (DTL) having a long axis, and said shielding structure includes generally cylindrical wrap-around outside structure directly associated with said DTL and wrapped around said long axis.

4. The system of claim 1 which further comprises an elongate, slender, high-energy beam transport (HEBT) operatively interposed said linac structure and said target zone and having a long axis, and said shielding structure includes a wrap-around outside structure enveloping said HEBT and wrapped around said long axis.

5. The system of claim 1, wherein said target zone is disposed adjacent one end of said linac structure, and said shielding structure includes a generally spherical bulb enveloping said target zone.

6. The system of claim 5, wherein said bulb is shaped generally in the form of an icosihexahedron.

7. A PET radioisotope production system having a lollipop form factor comprising
an elongate, slender linear accelerator (linac structure), and
a bulb-like target structure operatively disposed near, and functionally downstream relative to, one end of said linac structure.

8. The system of claims 7 which further comprises an elongate, slender, high-energy beam transport (HEBT) operatively interposed said linac and target structures.

9. The system of claim 7, wherein said target structure includes a plural-component, hinged assembly which can be opened and closed.

10. The system of claim 7, wherein said target structure has a generally icosihexahedron outside configuration.

11. A mobile, compact, transportable PET radioisotope production system mountable within a transport agency, comprising
an elongate, slender stem including linac structure, and
target bulb structure operatively disposed adjacent one end of said stem.

12. The system of claim 11, wherein said stem further includes a high-energy beam transport (HEBT).

13. The system of claim 10 with respect to which the transport agency takes the form of one of (a) a land vehicle, (b) a water vehicle, and (c) an air vehicle.

14. A mobile, compact and transportable PET radioisotope production system comprising
elongate linac structure having a discharge end, and including outside body structure which is formed as a first radiation-shielding substructure, and
target structure operatively disposed near said linac structure's said discharge end, and including outside body structure which is formed as a second radiation-shielding substructure,
wherein said first and second radiation-shielding substructures collectively form, effectively, an omnidirectional radiation self-shield for said system.

15. The system of claim 14, wherein said linac structure includes (a) an elongate ion injector having a long axis and upstream and downstream ends, (b) an elongate, linear radio frequency quadrupole (RFQ) having a long axis and upstream and downstream ends operatively coupled adjacent its upstream end co-axially to the downstream end of said ion injector, and (c) an elongate, linear drift tube linac (DTL) having a long axis and upstream and downstream ends operatively coupled adjacent its upstream end co-axially to the downstream end of said RFQ, and wherein, further, said first-mentioned radiation-shielding substructure is arranged to provide shielding around said RFQ and said DTL.

16. The system of claim 14, wherein said second-mentioned radiation-shielding substructure is bulb-like in configuration.

17. In a PET radioisotope production system, target structure comprising
a target zone, and
a generally bulb-like omnidirectional radiation shield substantially fully surrounding said zone.

18. The structure set forth in claim 17, wherein said shield takes the form of a plural-component, hinged assembly which allows for selective exposing and concealing of said zone.

19. The system of claim 17, wherein said shield has a somewhat spherical shape.

20. The system of claim 17, wherein said shield has a generally icosihexahedron outside configuration.

21. A PET radioisotope production system comprising
an accelerator having an upstream region and a downstream region, operable to accelerate an ion beam between its said upstream and downstream regions and for output delivery from said downstream region,
a target zone operatively coupled to said accelerator near and downstream from the latter's said downstream region, operable to present a target for impingement by such a delivered output beam, and
form-fitting radiation shielding structure effectively omnidirectionally shielding said accelerator and said target zone.

22. A linac system for PET radioisotope production comprising beam-generation-to-target structure including form-fitting, self-contained, omnidirectional radiation shielding substructure.
